(19) United States
(12) Patent Application Publication
(10) Pub. No.: US 2010/0251735 A1
(43) Pub. Date: Oct. 7, 2010

(54) REFRIGERATOR, AND METHOD FOR CONTROLLING OPERATION OF THE SAME

(75) Inventors: Jae-Seng SIM, Masan-Shi (KR); Young-Hwan KO, Changwon-Shi (KR); Jongmin SHIN, Nam-Ku (KR); Bong-Jun CHOI, Changwon-Shi (KR); Jun-Hyeon HWANG, Changwon-Shi (KR); Young JEONG, Gwangmeong-Shi (KR); Samchul HA, Changwon-Shi (KR); Yunho HWANG, Ellicott City, MD (US)

Correspondence Address: KED & ASSOCIATES, LLP, P.O. Box 221200, Chantilly, VA, 20153-1200, US

(73) Assignee: LG Electronics Inc.

(21) Appl. No.: 12/755,040

(22) Filed: Apr. 6, 2010

Related U.S. Application Data
(62) Division of application No. 10/871,703, filed on Jun. 21, 2004, now Pat. No. 7,726,141.
Application No. 10/871,703 is a continuation-in-part of application No. 10/537,828, filed on Jun. 8, 2005, now Pat. No. 7,584,627.

(30) Foreign Application Priority Data
Dec. 24, 2002 (KR) 10-2002-0083289
Dec. 16, 2003 (KR) PCT/KR03/02749

(51) Int. Cl. F25D 21/06; F25D 17/06; F25B 39/02; F25B 1/00; F25D 21/08; F25D 11/02; F16K 17/38; F25D 17/04

(52) U.S. Cl. 62/80; 62/419; 62/515; 62/498; 62/276; 62/441; 137/468; 62/186

(57) ABSTRACT

The present invention discloses a refrigerator which can individually cool a freezing chamber and a refrigerating chamber by dividing a heat exchange region of an evaporator into a freezing chamber side region and a refrigerating chamber side region, forming individual circulation passages for supplying cool air from each region to the freezing chamber and the refrigerating chamber, and forming a freezing chamber fan and a refrigerating chamber fan on each circulation passage, and method for controlling operation of the same which can efficiently perform a cooling operation and reduce power consumption by effectively controlling the operations of each component.

### TECHNICAL FIELD

The present invention relates to a refrigerator which can efficiently perform a cooling operation and reduce power consumption, by individually cooling a freezing chamber and a refrigerating chamber and effectively controlling the operations of each component, and a method for controlling an operation of the same.

### BACKGROUND ART

In general, a refrigerator is one of the living necessaries which preserves food fresh for a predetermined period, by lowering a temperature of a freezing chamber or a refrigerating chamber by repeating a refrigeration cycle of compressing, condensing, expanding and evaporating refrigerants.

The refrigerator has a refrigeration cycle including basic components such as a compressor for compressing refrigerants into high temperature high pressure gas refrigerants, a condenser for condensing the refrigerants from the compressor into high temperature high pressure liquid refrigerants, an expansion valve for decompressing the refrigerants from the condenser into low temperature low pressure liquid refrigerants, and an evaporator for maintaining a low temperature in a freezing chamber or a refrigerating chamber, by absorbing heat from the freezing chamber or the refrigerating chamber by evaporating the refrigerants from the expansion valve into low temperature low pressure gas refrigerants.

FIG. 1 is a schematic front perspective view illustrating a conventional side-by-side type refrigerator, and FIG. 2 is a structure view illustrating a refrigeration cycle applied to the refrigerator of FIG. 1.

The conventional side-by-side type refrigerator in which a freezing chamber and a refrigerating chamber are disposed side by side will now be described with reference to FIGS. 1 and 2. A refrigeration cycle including a compressor 12, a condenser 14, an expansion valve 16 and an evaporator 18 is built in an inner wall, for generating cool air by the evaporator 18. The freezing chamber F maintaining about −18° C. by sucking most of the cool air, and the refrigerating chamber R maintaining about 0 to 7° C. by sucking part of the cool air are disposed side by side at both sides of a main body 2.

The refrigeration cycle includes basic components, and thus explanations thereof are omitted.

Here, the freezing chamber F and the refrigerating chamber R are divided by a cross wall 4. Part of the cross wall 4 is opened so that the cool air can flow between the freezing chamber F and the refrigerating chamber R.

The evaporator 18 is installed on the inner wall in the freezing chamber F, and a blast fan 22 is installed at the upper portion of the evaporator 18, for sending cool air generated in the evaporator 18 to the freezing chamber F or the refrigerating chamber R. Generally, an axial flow fan for sucking and discharging cool air in an axial direction is used.

The freezing chamber F and the refrigerating chamber R compose a cool air circulation structure for circulating cool air near the evaporator 18 through the freezing chamber F and the refrigerating chamber R by the operation of the blast fan 22, and returning the cool air to the evaporator 18.

The operations of the components of the refrigerator are controlled by a microcomputer (not shown). The microcomputer controls the whole components so that a temperature Tf of the freezing chamber F and a temperature Tr of the refrigerating chamber R can reach a set freezing temperature Tf₀ and a set refrigerating temperature Tr₀ setting by the user or automatically set.

In the conventional refrigerator, when a load is applied, the compressor 12 is operated according to a control signal from the microcomputer, and refrigerants are circulated though the compressor 12, the condenser 14, the expansion valve 16 and the evaporator 18, for cooling air near the evaporator 18 and generating cool air.

In addition, the blast fan 22 is operated according to a control signal from the microcomputer, so that most of the cool air near the evaporator 18 can be supplied to the freezing chamber F and part of the cool air can be supplied to the refrigerating chamber R. The cool air circulated in the freezing chamber F and the refrigerating chamber R to have a high temperature is re-supplied to the evaporator 18.

In the conventional refrigerator, one evaporator 18 is installed in the is freezing chamber F, and the cool air heat-exchanged through the evaporator 18 is partially distributed and supplied to the refrigerating chamber R on the passage of the freezing chamber F. Accordingly, when the inside temperature of any one of the freezing chamber F and the refrigerating chamber R does not satisfy the set freezing temperature Tf₀ or the set refrigerating temperature Tr₀, the compressor 12 and the blast fan 22 are operated to lower the temperature, thereby increasing power consumption or supercooling food.

For example, when the temperature Tf of the freezing chamber F reaches the set freezing temperature Tf₀, if the temperature Tr of the refrigerating chamber R does not satisfy the set refrigerating temperature Tr₀, the temperature Tr of the refrigerating chamber R must be lowered to reach the set refrigerating temperature Tr₀ by operating the compressor 12 and the blast fan 22. Here, the cool air is also supplied to the freezing chamber F, to unnecessarily lower the temperature Tf of the freezing chamber F. In addition, power consumption increases.

On the other hand, when the temperature Tr of the refrigerating chamber R reaches the set refrigerating temperature Tr₀, if the temperature Tf of the freezing chamber F does not satisfy the set freezing temperature Tf₀, the temperature Tf of the freezing chamber F must be lowered to reach the set freezing temperature Tf₀ by operating the compressor 12 and the blast fan 22. The cool air is also supplied to the refrigerating chamber R, to unnecessarily lower the temperature Tr of refrigerating chamber R. Moreover, food is supercooled.

In the conventional refrigerator, part of the cool air from the evaporator 18 is distributed to the refrigerating chamber R. A volume of the cool air distributed to the refrigerating chamber R is relatively smaller than a volume of the cool air distributed to the freezing chamber F. Therefore, a cooling speed of the refrigerating chamber R is reduced, to unnecessarily operate the compressor 12.

For example, when the temperature Tr of the refrigerating chamber R does not reach the set refrigerating temperature Tr₀, the compressor 12 is operated until the temperature Tr of the refrigerating chamber R reaches the set refrigerating temperature Tr₀. Accordingly, an excessive load is applied to the compressor 12 to reduce the temperature of the evaporator 18 lower than the temperature Tf of the freezing chamber F.

### DISCLOSURE OF THE INVENTION

The present invention is achieved to solve the above problems. An object of the present invention is to provide a refrigerator which can improve cooling efficiency and reduce power consumption, by individually cooling a freezing chamber and a refrigerating chamber, and a method for controlling an operation of the same.

Another object of the present invention is to provide a refrigerator which can prevent a compressor from being unnecessarily operated, by increasing a cooling speed of a refrigerating chamber as well as a cooling speed of a freezing chamber so that a temperature of the refrigerating chamber can rapidly reach a set refrigerating temperature, and a method for controlling an operation of the same.

Yet another object of the present invention is to provide a refrigerator which can increase an inside capacity of a freezing chamber or a refrigerating chamber, and a method for controlling an operation of the same.

Yet another object of the present invention is to provide a refrigerator which can prevent an evaporator from being frosted and effectively perform a defrosting operation, and a method for controlling an operation of the same.

In order to achieve the above-described objects of the present invention, there is provided a refrigerator including: a compressor for compressing refrigerants into high temperature high pressure gas refrigerants; a condenser for condensing the refrigerants compressed in the compressor into high temperature high pressure liquid refrigerants; a decompression means for expanding the refrigerants condensed in the condenser into low temperature low pressure liquid refrigerants; an evaporator for evaporating the refrigerants expanded in the decompression means into low temperature low pressure gas refrigerants, a heat exchange region of which being divided into a freezing chamber side region and a refrigerating chamber side region; and an air blast device linked respectively to the freezing chamber side region and the refrigerating chamber side region of the evaporator, for sending cool air from each region to a freezing chamber and a refrigerating chamber.

According to another aspect of the present invention, a method for controlling an operation of a refrigerator includes: a first step for compressing refrigerants into high temperature high pressure gas refrigerants according to a freezing load or a refrigerating load applied to a freezing chamber or a refrigerating chamber, a second step for condensing the refrigerants compressed in the first step into high temperature high pressure liquid refrigerants by performing a heat exchange operation with air, a third step for decompressing the refrigerants condensed in the second step into low temperature low pressure liquid refrigerants by controlling a decompression degree according to the load; and a fourth step for generating cool air by evaporating the refrigerants decompressed in the third step into low temperature low pressure gas refrigerants by performing a heat exchange operation with air, and selectively sending the cool air to the freezing chamber, the refrigerating chamber, or both the freezing chamber and the refrigerating chamber according to the load.

### BRIEF DESCRIPTION OF THE DRAWINGS

The present invention will become better understood with reference to the accompanying drawings which are given only by way of illustration and thus are not limitative of the present invention, wherein:

FIG. 1 is a schematic front perspective view illustrating a conventional side-by-side type refrigerator;

FIG. 2 is a structure view illustrating a refrigeration cycle applied to the refrigerator of FIG. 1;

FIG. 3 is a front perspective view illustrating a side-by-side type refrigerator in accordance with a first embodiment of the present invention;

FIG. 4 is a cross-sectional view illustrating the refrigerator of FIG. 3;

FIG. 5 is a front perspective view illustrating a side-by-side type refrigerator in accordance with a second embodiment of the present invention;

FIG. 6 is a cross-sectional view illustrating the refrigerator of FIG. 5;

FIG. 7 is a structure view illustrating a first example of a refrigeration cycle applied to the refrigerators of FIGS. 3 and 5;

FIG. 8 is a structure view illustrating a second example of the refrigeration cycle applied to the refrigerators of FIGS. 3 and 5;

FIG. 9 is a structure view illustrating a third example of the refrigeration cycle applied to the refrigerators of FIGS. 3 and 5;

FIG. 10 is a perspective view illustrating a first example of an evaporator applied to the refrigerators of FIGS. 3 and 5;

FIG. 11 is a perspective view illustrating a second example of the evaporator applied to the refrigerators of FIGS. 3 and 5; and

FIG. 12 is a flowchart showing sequential steps of a method for controlling an operation of a refrigerator in accordance with a preferred embodiment of the present invention.

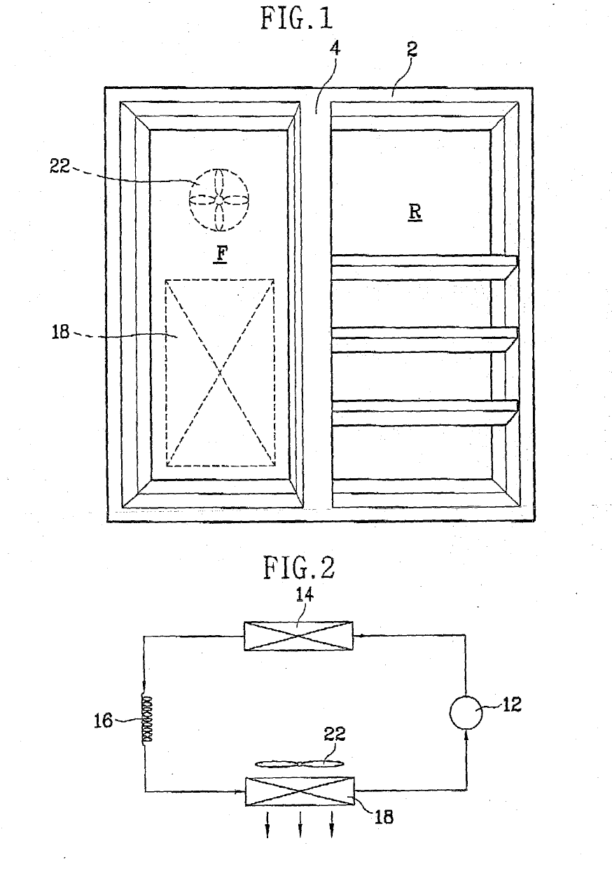

### BEST MODE FOR CARRYING OUT THE INVENTION

A refrigerator and a method for controlling an operation of the same in accordance with the present invention will now be described in detail with reference to the accompanying drawings.

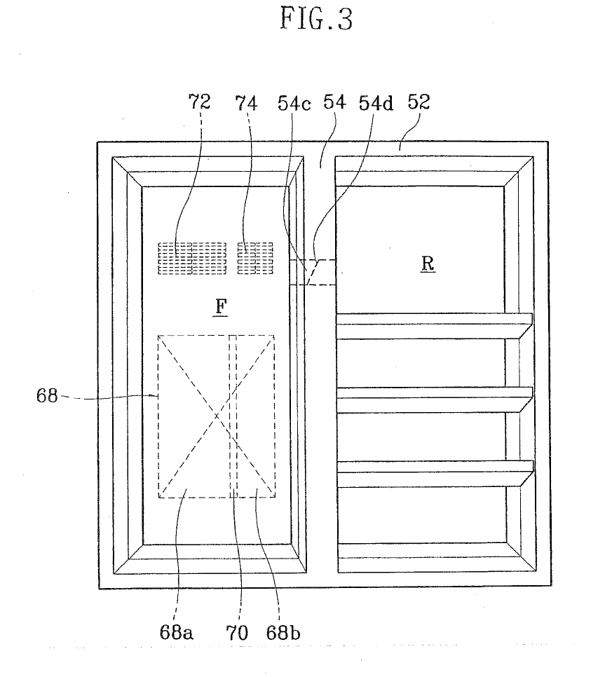

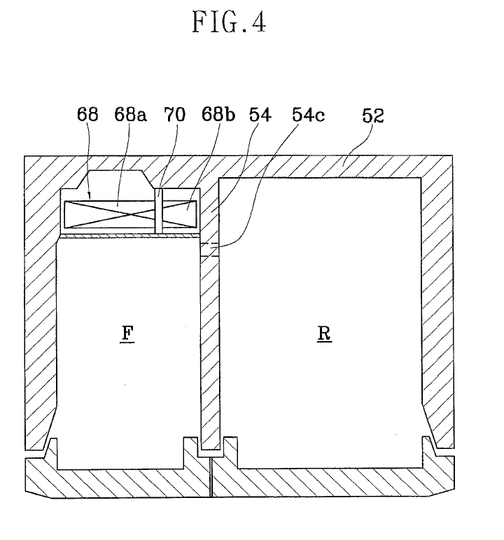

FIG. 3 is a front perspective view illustrating a side-by-side type refrigerator in accordance with a first embodiment of the present invention, and FIG. 4 is a cross-sectional view illustrating the refrigerator of FIG. 3.

The refrigerator in accordance with the first embodiment of the present invention will now be described with reference to FIGS. 3 and 4. A freezing chamber F and a refrigerating chamber R are disposed side by side at both sides of a main body 52 from a cross wail 54. A compressor (not shown), a condenser (not shown) and an expansion means (not shown) are built in a machine room (not shown) formed at one side of the freezing chamber F and the refrigerating chamber R. An evaporator 68 is built in the freezing chamber F, for generating cool air by performing a heat exchange operation with refrigerants.

Especially, the evaporator 68 is divided into a freezing chamber side region 68a and a refrigerating chamber side region 68b. Individual circulation passages are formed to circulate the cool air heat-exchanged in each region in the freezing chamber F and the refrigerating chamber R, respectively. A freezing chamber fan 72 and a refrigerating chamber fan 74 for sending the cool air from the freezing chamber side region 68a and the refrigerating chamber side region 68b to the freezing chamber F and the refrigerating chamber R, respectively, and motors (not shown) for driving the fans 72 and 74 are installed on the circulation passages to be linked to the freezing chamber side region 68a and the refrigerating chamber side region 68b.

Preferably, the compressor is a capacity variable compressor such as an inverter compressor or a linear compressor to control a compression flow rate, and the expansion means is a capillary tube having a relatively small refrigerant tube diameter or an electronic expansion valve controlling opening.

In the evaporator 68, a heat exchange region is divided by a special blocking plate 70 so that the freezing chamber side region 68a and the refrigerating chamber side region 68b can be disposed side by side.

Here, the evaporator 68 is a straight type thin heat exchanger in which a plurality of cooling fins 68B are installed vertically to a refrigerant tube 68A. The blocking plate 70 is installed between the cooling fins 68B. A plurality of grooves (not shown) are formed on the surface of the blocking plate 70, for forming a turbulent bed to the cool air flowing along the surface of the evaporator 68, thereby improving heat exchange efficiency.

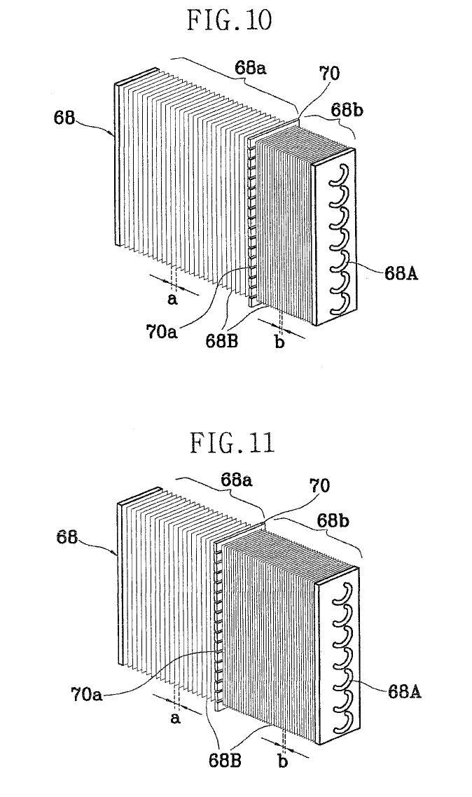

As shown in FIG. 10, in the evaporator 68, the freezing chamber side region 68a and the refrigerating chamber side region 68b can have the same area. Generally, in order to maintain the freezing chamber F at a lower temperature then the refrigerating chamber R, lower temperature cool air is necessary in the freezing chamber F. Accordingly, as depicted in FIG. 11, the freezing chamber side region 68a is preferably larger than the refrigerating chamber side region 68b.

In addition, in the evaporator 68, the freezing chamber side region 68a maintains a lower temperature than the refrigerating chamber side region 68b, and thus is more easily frosted than the refrigerating chamber side region 68b. Therefore, a cooling fin pitch a of the freezing chamber side region 68a is set wider than a cooling fin pitch b of the refrigerating chamber side region 68b, to efficiently prevent frost.

The refrigerating chamber side region 68b is narrower than the freezing chamber side region 68a, to reduce heat exchange efficiency. Here, the cooling fan pitch b of the refrigerating chamber side region 68b is narrower than the cooling fan pitch a of the freezing chamber side region 68a. Accordingly, more cooling fins are installed in a unit area of the refrigerating chamber side region 68b, thereby improving heat exchange efficiency in the refrigerating chamber side region 68b.

Preferably, at least one defrosting heater (not shown) is installed at the lower portion of the evaporator 68, for performing a defrosting operation. A defrosting heater (not shown) for the freezing chamber F is installed at the lower portion of the freezing chamber side region 68a, for defrosting the freezing chamber side region 68a, and a defrosting heater (not shown) for the refrigerating chamber R is installed at the lower portion of the refrigerating chamber side region 68b, for defrosting the refrigerating chamber side region 68b.

Preferably, the defrosting heater for the freezing chamber F and the defrosting heater for the refrigerating chamber R are radiant heaters for transmitting heat to the evaporator 68 by radiation. The defrosting heater for the freezing chamber F has a larger capacity than the defrosting heater for the refrigerating chamber R, thereby rapidly defrosting the freezing chamber side region 68a.

The freezing chamber fan 72 and the refrigerating chamber fan 74 are disposed side by side at the upper portions of the freezing chamber side region 68a and the refrigerating chamber side region 68b, for sending the refrigerants from the evaporator 68 to the freezing chamber F and the refrigerating chamber R, respectively. Recently, as a large volume of cool air is required due to increase of a capacity of the refrigerator, sirocco fans which are centrifugal fans which have a relatively large air blast volume and which can be effectively installed in a restricted space of the upper portion of the evaporator 68 which is a thin heat exchanger are used as the freezing chamber fan 72 and the refrigerating chamber fan 74.

That is, the freezing chamber fan 72 and the refrigerating chamber fan 74 are sirocco fans for sucking air in an axial direction and discharging air in a radius direction. Therefore, the freezing chamber fan 72 and the refrigerating chamber fan 74 are disposed side by side at the upper portion of the evaporator 68 in an axial direction and installed on the individual circulation passages, respectively, so that the cool air from the evaporator 68 can be supplied to both sides of the freezing chamber fan 72 and the refrigerating chamber fan 74 and discharged to the front surface thereof.

Preferably, the motors for driving the freezing chamber fan 72 and the refrigerating chamber fan 74 are BLDC motors. Because the BLDC motor uses a driving circuit for converting an alternating current to a direct current instead of using a brush, the BLDC motor does not generate a spark by a carbon material brush, prevents gas explosion, is stably driven in most of rotation numbers, and maintains high efficiency of 70 to 80%.

In accordance with the first embodiment of the present invention, there are formed the circulation passage for the freezing chamber F for discharging the cool air from the freezing chamber side region 68a of the evaporator 68 to the freezing chamber F, circulating the cool air in the freezing chamber F, and re-supplying the circulated air to the freezing chamber side region 68a of the evaporator 68, and the circulation passage for the refrigerating chamber R for discharging the cool air from the refrigerating chamber side region 68b of the evaporator 68 to the refrigerating chamber R, circulating the cool air in the refrigerating chamber R, and re-supplying the circulated air to the refrigerating chamber side region 68b.

Here, the evaporator 68 is installed on the inner wall of the freezing chamber F. Accordingly, the circulation passage for the refrigerating chamber R including a suction passage for the refrigerating chamber R and a discharge passage for the refrigerating chamber R is formed between the refrigerating chamber side region 68b and the refrigerating chamber R, and the circulation passage for the freezing chamber F is automatically formed in the other regions.

The cool air is individually circulated in the freezing chamber F and the refrigerating chamber R to efficiently cool the freezing chamber F and the refrigerating chamber R. Even if a door of the freezing chamber F or the refrigerating chamber R is opened/closed, the other door is not moved.

On the other hand, a connection passage (not shown) is formed on the cross wall 54 between the freezing chamber F and the refrigerating chamber R, so that the cool air can flow therethrough. A damper (not shown) is installed to be opened/closed on the connection passage. The damper is opened/closed by the microcomputer for controlling the operation of the refrigerator, for supplying part of the cool air of the freezing chamber F to the refrigerating chamber R.

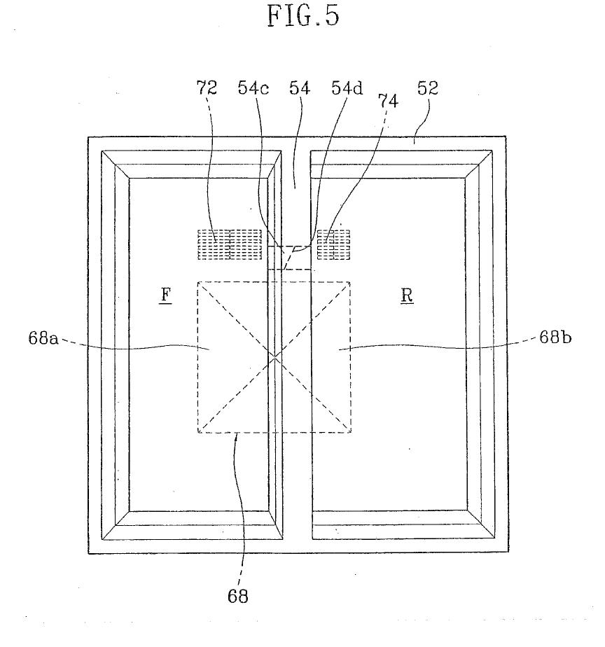

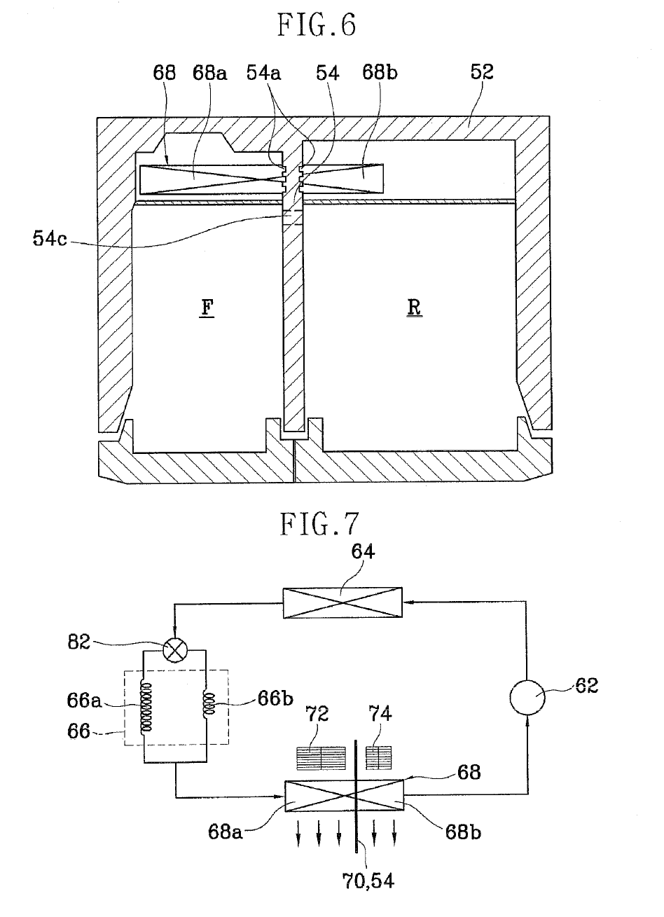

FIG. 5 is a front perspective view illustrating a side-by-side type refrigerator in accordance with a second embodiment of the present invention, and FIG. 6 is a cross-sectional view illustrating the refrigerator of FIG. 5.

The refrigerator in accordance with the second embodiment of the present invention will now be explained with reference to FIGS. 5 and 6. Identically to the first embodiment, a freezing chamber F and a refrigerating chamber R are disposed side by side at both sides of a main body 52 from a cross wall 54. A compressor (not shown), a condenser (not shown) and an expansion means (not shown) are built in a machine room (not shown) formed at one side of the freezing chamber F and the refrigerating chamber R. An evaporator 68 is built in the freezing chamber F and the refrigerating chamber R for generating cool air by performing a heat exchange operation with refrigerants.

Especially, the evaporator 68 is divided into a freezing chamber side region 68a and a refrigerating chamber side region 68b by the cross wall 64. individual circulation passages are formed to circulate the cool air heat-exchanged in each region in the freezing chamber F and the refrigerating chamber R, respectively. A freezing chamber fan 72 and a refrigerating chamber fan 74 for sending the cool air from the freezing chamber side region 68a and the refrigerating chamber side region 68b to the freezing chamber F and the refrigerating chamber R, respectively, and motors (not shown) for driving the fans 72 and 74 are installed on the circulation passages to be linked to the freezing chamber side region 68a and the refrigerating chamber side region 68b.

Preferably, the compressor and the expansion means are formed in the same manner as those of the first embodiment.

In the evaporator 68, a heat exchange region is divided by the cross wall 54 so that the freezing chamber side region 68a and the refrigerating chamber side region 68b can be disposed side by side. A plurality of grooves (not shown) are formed on the surface of the cross wail 54, for forming a turbulent bed to the cool air flowing along the surface of the evaporator 68, thereby improving heat exchange efficiency.

The evaporator 68 is a straight type thin heat exchanger in which a plurality of cooling fins 68B are installed vertically to a refrigerant tube 68A. As shown in FIG. 10, the freezing chamber side region 68a and the refrigerating chamber side region 68b can have the same area, or as depicted in FIG. 11, the freezing chamber side region 68a can be larger than the refrigerating chamber side region 68b. A cooling fin pitch a of the freezing chamber side region 68a is set wider than a cooling fin pitch b of the refrigerating chamber side region 68b, to efficiently prevent the freezing chamber side region 68a from being frosted and improve heat exchange efficiency in the refrigerating chamber side region 68b.

Preferably, at least one defrosting heater (not shown) is installed at the lower portion of the evaporator 68, for performing a defrosting operation. The defrosting heaters are also formed in the same manner as those of the first embodiment.

The freezing chamber fan 72, the refrigerating chamber fan 74, and the motors for driving the fans 72 and 74 are formed in the same manner as those of the first embodiment.

In accordance with the second embodiment of the present invention, there are formed the circulation passage for the freezing chamber F for discharging the cool air from the freezing chamber side region 68a of the evaporator 68 to the freezing chamber F, circulating the cool air in the freezing chamber F, and re-supplying the circulated air to the freezing chamber side region 68a of the evaporator 68, and the circulation passage for the refrigerating chamber R for discharging the cool air from the refrigerating chamber side region 68b of the evaporator 68 to the refrigerating chamber R, circulating the cool air in the refrigerating chamber R, and re-supplying the circulated air to the refrigerating chamber side region 68b.

In the evaporator 68, the freezing chamber side region 68a is disposed on the inner wall of the freezing chamber F, and the refrigerating chamber side region 68b is disposed on the inner wall of the refrigerating chamber R. Here, the freezing chamber side region 68a and the refrigerating chamber side region 68b are divided by the cross wall 54. Accordingly, the circulation passage for the freezing chamber F and the circulation passage for the refrigerating chamber R need not to be specially divided.

A connection passage (not shown) is formed on the cross wall 54 between the freezing chamber F and the refrigerating chamber R, so that the cool air can flow therethrough. A damper (not shown) is installed to be opened/closed on the connection passage. The damper is opened/closed by the microcomputer for controlling the operation of the refrigerator, for supplying part of the cool air of the freezing chamber F to the refrigerating chamber R.

FIG. 7 is a structure view illustrating a first example of a refrigeration cycle applied to the refrigerators of FIGS. 3 and 5.

The first example of the refrigeration cycle which can be applied to the refrigerators in accordance with the first and second embodiments of the present invention will now be explained. The refrigeration cycle includes a compressor 62 for compressing refrigerants into high temperature high pressure gas refrigerants, a condenser 64 for condensing the refrigerants compressed in the compressor 62 into high temperature high pressure liquid refrigerants by performing a heat exchange operation with outdoor air, an expansion means 66 having a freezing expansion valve 66a or a refrigerating expansion valve 66b for decompressing the refrigerants condensed in the condenser 64 into low temperature low pressure liquid refrigerants by controlling a decompression degree according to a load, a three way valve 82 for controlling the refrigerants discharged from the condenser 64 to be selectively supplied to the freezing expansion valve 66a or the refrigerating expansion valve 66b, and an evaporator 68 for evaporating the to refrigerants decompressed in the expansion means 66 into low temperature low pressure gas refrigerants by performing a heat exchange operation with air in a freezing chamber F or a refrigerating chamber R, and generating cool air at the same time.

The evaporator 68 is divided into a freezing chamber side region 68a and a refrigerating chamber side region 68b. A freezing chamber fan 72 and a motor are installed to be linked to the freezing chamber side region 68a, so that the cool air passing through to freezing chamber side region 68a can be supplied merely to the freezing chamber F. A refrigerating chamber fan 74 and a motor are installed to be linked to the refrigerating chamber side region 68b, so that the cool air passing through the refrigerating chamber side region 68b can be supplied merely to the refrigerating chamber R.

In detail, a constant speed compressor can be used as the compressor 62. However, the compressor 62 is preferably a capacity variable compressor for controlling a flow rate of the refrigerants circulated in the refrigeration cycle and controlling a compression degree of the refrigerants. For example, an inverter compressor or a linear compressor which can vary a rotation number is used as the compressor 62.

The condenser 64 is a heat exchanger. In order efficiently perform the heat exchange operation with outdoor air, a special fan (not shown) can be installed adjacently to the condenser 64.

The freezing expansion valve 86a and the refrigerating expansion valve 66b are disposed side by side. Refrigerant tubes formed at the front and rear ends of the freezing expansion valve 66a and the refrigerating expansion valve 66b are coupled to each other, respectively. Capillary tubes having a relatively small refrigerant tube diameter or electronic expansion valves controlling opening can be used.

Here, the freezing expansion valve 66a and the refrigerating expansion valve 66b are different in capacity. The freezing expansion valve 66a has a relatively larger decompression capacity than the refrigerating expansion valve 66b. The freezing expansion valve 66a and the refrigerating expansion valve 66b can switch the passages of the refrigerants according to each load.

The three way valve 82 controls the refrigerants from the condenser 64 to be supplied in one direction of the freezing expansion valve 66a or the refrigerating expansion valve 66b. Preferably, the three way valve 82 is installed on the refrigerant tubes branched into the freezing expansion valve 66a and the refrigerating expansion valve 66b.

Here, the three way valve 82 controls the refrigerants to pass through the freezing expansion valve 66a so that a temperature Tf of the freezing chamber F can reach a set freezing temperature Tf₀, and controls the refrigerants to pass through the refrigerating expansion valve 66b so that a temperature Tr of the refrigerating chamber R can reach a set refrigerating temperature Tr₀.

The evaporator 68 is installed so that the freezing chamber side region 68a and the refrigerating chamber side region 68b can be linked to the freezing chamber F and the refrigerating chamber R, respectively. The freezing chamber fan 72, the refrigerating chamber fan 74, and the motors for driving the fans 72 and 74 are installed on each passage.

Preferably, the evaporator 68 is a straight type thin heat exchanger, the freezing chamber fan 72 and the refrigerating chamber fan 74 are sirocco fans, and the motors are BLCD motors.

While the compressor 62 is operated, the low temperature low pressure gas refrigerants are circulated in the freezing chamber side region 68a and the refrigerating chamber side region 68b of the evaporator 68. Accordingly, the cool air is supplied to the freezing chamber F or the refrigerating chamber R according to the operations of the freezing chamber fan 72 and the refrigerating chamber fan 74.

Here, the freezing chamber fan 72 sends the cool air from the freezing chamber side region 68a to the freezing chamber F so that the temperature Tf of the freezing chamber F can reach the set freezing temperature Tf₀, and the refrigerating chamber fan 74 sends the cool air from the refrigerating chamber side region 68b to the refrigerating chamber R so that the temperature Tr of the refrigerating chamber R can reach the set refrigerating chamber Tr₀.

The evaporator 68 is formed to individually link the freezing chamber side region 68a and the refrigerating chamber side region 68b to the freezing chamber F and the refrigerating chamber R, and to have circulation passages for circulating cool air in the freezing chamber F and the refrigerating chamber R, respectively.

The operations of the above-described components are controlled by a microcomputer (not shown).

The operation of the first example of the refrigeration cycle will now be described.

In a freezing mode for making the temperature Tf of the freezing chamber F reach the set freezing temperature Tf₀, the microcomputer controls the three way valve 82 so that the refrigerants can pass through the freezing expansion valve 66a, operates the freezing chamber fan 72, and stops the refrigerating chamber fan 74.

Therefore, the refrigerants are circulated through the compressor 62, the condenser 64, the freezing expansion valve 66a and the evaporator 68. As the freezing chamber fan 72 is operated, the cool air heat-exchanged in the freezing chamber side region 68a is supplied merely to the freezing chamber F, to cool the freezing chamber F.

In a refrigerating mode for making the temperature Tr of the refrigerating chamber R reach the set refrigerating temperature Tr₀, the microcomputer controls the three way valve 82 so that the refrigerants can pass through the refrigerating expansion valve 66b, operates the refrigerating chamber fan 74, and stops the freezing chamber fan 74.

Accordingly, the refrigerants are circulated through the compressor 62, the condenser 64, the refrigerating expansion valve 66b and the evaporator 68. As the refrigerating chamber fan 74 is operated, the cool air heat-exchanged in the refrigerating chamber side region 68b is supplied merely to the refrigerating chamber R, to cool the refrigerating chamber R.

In a freezing and refrigerating mode for making the temperature Tf of the freezing chamber F and the temperature Tr of the refrigerating chamber R reach the set freezing temperature Tf₀ and the set refrigerating temperature Tr₀, respectively, the three way valve 82 makes the refrigerants to pass through the freezing expansion valve 66a, the freezing chamber fan 72 is continuously operated, and the refrigerating chamber fan 74 is operated and stopped at intervals of a predetermined time.

As a result, the refrigerants are circulated through the compressor 62, the condenser 64, the freezing expansion valve 66a and the evaporator 68. As the freezing chamber fan 72 is operated, the cool air heat-exchanged in the freezing chamber side region 68a is supplied to the freezing chamber F, and as the refrigerating chamber fan 74 is intermittently operated, the cool air heat-exchanged in the refrigerating chamber side region 68b is supplied to the refrigerating chamber R during the operation, thereby cooling both the freezing chamber F and the refrigerating chamber R.

In a defrosting mode for making the temperature Tf of the freezing chamber F and the temperature Tr of the refrigerating chamber R reach a defrosting temperature Ti for removing ice from the surface of the evaporator 68, the compressor 62 is stopped, the freezing chamber fan 72 is stopped, and the refrigerating chamber fan 74 is operated.

In a state where the refrigerants are not circulated, the refrigerating chamber side region 68b of the evaporator 68 is defrosted by the air sent by the operation of the refrigerating chamber fan 74, and the freezing chamber side region 68a of the evaporator 68 is defrosted by the heat transmitted from the refrigerating chamber side region 68b.

In the defrosting mode, if the temperature Tf of the freezing chamber F and the temperature Tr of the refrigerating chamber R do not reach the defrosting temperature Ti, defrosting heaters installed at the lower portion of the evaporator 68 are heated to defrost the evaporator 68.

The first example of the refrigeration cycle improves the cooling speed of the refrigerating chamber R more than the general refrigeration cycle by cooling the freezing chamber F and the refrigerating chamber R, respectively, efficiently cools a large capacity of refrigerator, and individually effectively defrosts the freezing chamber F and the refrigerating chamber R.

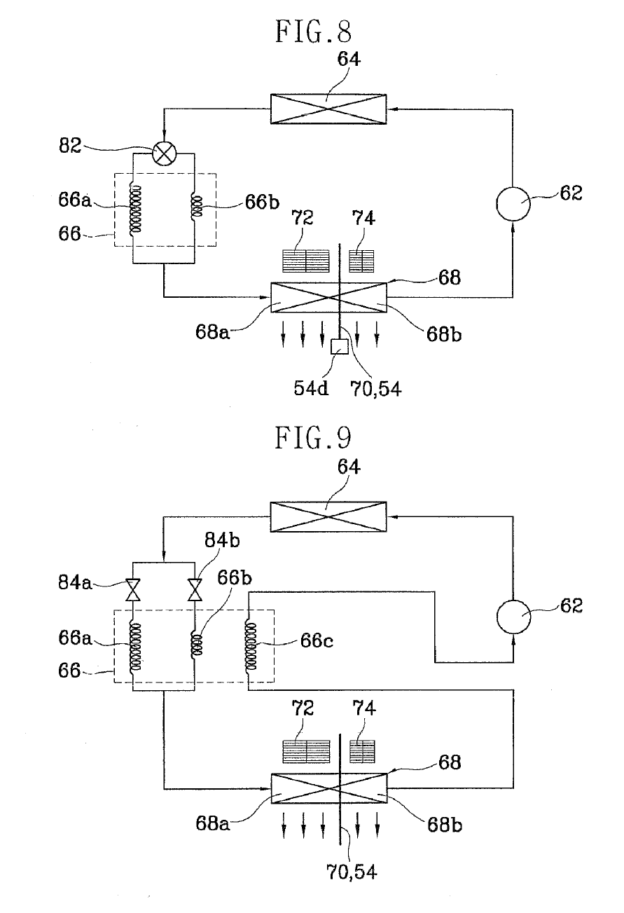

FIG. 8 is a structure view illustrating a second example of the refrigeration cycle applied to the refrigerators of FIGS. 3 and 5.

The second example of the refrigeration cycle which can be applied to the refrigerators in accordance with the first and second embodiments of the present invention will now be explained. The second example of the refrigeration cycle is basically identical to the first example of the refrigeration cycle. However, a connection passage (not shown) is formed between the freezing chamber F and the refrigerating chamber R, so that the cool air can flow therethrough, and a damper 76 is installed to be opened/closed on the connection passage.

Accordingly, the second example of the refrigeration cycle is operated in the same manner as the first example of the refrigeration cycle. However, in the freezing mode, if the temperature Tr of the refrigerating chamber R is higher than the set refrigerating temperature Tr₀, the damper 76 is opened to supply part of the cool air of the freezing chamber F to the refrigerating chamber R, thereby controlling the temperature Tr of the refrigerating chamber R.

That is, when the temperature Tr of the refrigerating chamber R increases in the freezing mode, the temperature Tr of the refrigerating chamber R can be easily controlled by supplying the cool air of the freezing chamber F having a relatively low temperature to the refrigerating chamber R. Therefore, the refrigerating chamber fan 74 needs not to be driven, which results in low power consumption.

FIG. 9 is a structure view illustrating a third example of the refrigeration cycle applied to the refrigerators of FIGS. 3 and 5.

The third example of the refrigeration cycle which can be applied to the refrigerators in accordance with the first and second embodiments of the present invention will now be explained. The refrigeration cycle includes a compressor 62 for compressing refrigerants into high temperature high pressure gas refrigerants, a condenser 64 for condensing the refrigerants compressed in the compressor 62 into high temperature high pressure liquid refrigerants by performing a heat exchange operation with outdoor air, an expansion means 66 having a freezing expansion valve 66a or a refrigerating expansion valve 66b for decompressing the refrigerants condensed in the condenser 64 into low temperature low pressure liquid refrigerants by controlling a decompression degree according to a load, first and second solenoid valves 84a and 84b installed on refrigerant tubes formed at the front ends of the freezing expansion valve 66a and the refrigerating expansion valve 66b, respectively, for controlling the refrigerant tubes to be opened/closed, and an evaporator 68 for evaporating the refrigerants decompressed in the expansion means 66 into low temperature low pressure gas refrigerants by performing a heat exchange operation with air in a freezing chamber F or a refrigerating chamber R, and generating cool air at the same time.

The evaporator 68 is divided into a freezing chamber side region 68a and a refrigerating chamber side region 68b. A freezing chamber fan 72 and a motor are installed to be linked to the freezing chamber side region 68a, so that the cool air passing through the freezing chamber side region 68a can be supplied merely to the freezing chamber F. A refrigerating chamber fan 74 and a motor are installed to be linked to the refrigerating chamber side region 68b, so that the cool air passing through the refrigerating chamber side region 68b can be supplied merely to the refrigerating chamber R.

In detail, the compressor 62, the condenser 64, the freezing expansion valve 66a, the refrigerating expansion valve 66b, the evaporator 68, the freezing chamber fan 72 and the refrigerating chamber fan 74 are formed in the same manner as those of the first embodiment.

The expansion means 66 further includes an auxiliary expansion valve 66c for intermediately cooling the refrigerants from the evaporator 68 by decompression, and re-supplying the refrigerants to the compressor 62. That is, the refrigerants are intermediately cooled between the evaporator 68 and the compressor 62, thereby improving efficiency of the whole refrigeration cycle.

The first and second solenoid valves 84a and 84b are installed on the refrigerant tubes at the front ends of the freezing expansion valve 66a and the refrigerating expansion valve 66b, for controlling the refrigerant tubes to be opened/closed. Therefore, the first and second solenoid valves 84a and 84b supply the refrigerants from the condenser 64 to the freezing expansion valve 65a, the refrigerating expansion valve 66b, or both the freezing expansion valve 66a and the refrigerating expansion valve 66b.

The operations of the above-described components are controlled by a microcomputer (not shown).

The operation of the third example of the refrigeration cycle will now be described.

In a freezing mode for making a temperature Tf of the freezing chamber F reach a set freezing temperature Tf₀, the microcomputer opens the first solenoid valve 84a and closes the second solenoid valve 84b, so that the refrigerants can pass through the freezing expansion valve 66a, operates the freezing chamber fan 72, and stops the refrigerating chamber fan 74.

Therefore, the refrigerants are circulated through the compressor 62, the condenser 64, the freezing expansion valve 66a, the evaporator 68 and the auxiliary expansion valve 66c. As the freezing chamber fan 72 is operated, the cool air heat-exchanged in the freezing chamber side region 68a is supplied merely to the freezing chamber F, to cool the freezing chamber F.

In a refrigerating mode for making a temperature Tr of the refrigerating chamber R reach a set refrigerating temperature Tr₀, the microcomputer closes the first solenoid valve 84a and opens the second solenoid valve 84b, so that the refrigerants can pass through the refrigerating expansion valve 66b, operates the refrigerating chamber fan 74, and stops the freezing chamber fan 72.

Accordingly, the refrigerants are circulated through the compressor 62, the condenser 64, the refrigerating expansion valve 66b, the evaporator 68 and the auxiliary expansion valve 66c. As the refrigerating chamber fan 74 is operated, the cool air heat-exchanged in the refrigerating chamber side region 68b is supplied merely to the refrigerating chamber R, to cool the refrigerating chamber R.

In a freezing and refrigerating mode for making the temperature Tf of the freezing chamber F and the temperature Tr of the refrigerating chamber R reach the set freezing temperature Tf₀ and the set refrigerating temperature Tr₀, respectively, the first solenoid valve 84a is opened and the second solenoid valve 84b is closed, so that the refrigerants can pass through the freezing expansion valve 66a, the freezing chamber fan 72 is continuously operated, and the refrigerating chamber fan 74 is operated and stopped at intervals of a predetermined time.

As a result, the refrigerants are circulated through the compressor 62, the condenser 64, the freezing expansion valve 66a, the evaporator 68 and the auxiliary expansion valve 66c. As the freezing chamber fan 72 is operated, the cool air heat-exchanged in the freezing chamber side region 68a is supplied to the freezing chamber F, and as the refrigerating chamber fan 74 is intermittently operated, the cool air heat-exchanged in the refrigerating chamber side region 68b is supplied to the refrigerating chamber R during the operation, thereby cooling both the freezing chamber F and the refrigerating chamber R.

In a defrosting mode for making the temperature Tf of the freezing chamber F and the temperature Tr of the refrigerating chamber R reach a defrosting temperature Ti for removing ice from the surface of the evaporator 68, the compressor 62 is stopped, the first and second solenoid valves 84a and 84b are closed, the freezing chamber fan 72 is stopped, and the refrigerating chamber fan 74 is operated.

In a state where the refrigerants are not circulated, the refrigerating chamber side region 68b of the evaporator 68 is defrosted by the air sent by the operation of the refrigerating chamber fan 74, and the freezing chamber side region 68a of the evaporator 68 is defrosted by the heat transmitted from the refrigerating chamber side region 68b.

In the defrosting mode, if the temperature Tf of the freezing chamber F and the temperature Tr of the refrigerating chamber R do not reach the defrosting temperature Ti, the first and second solenoid valves 84a and 84b are opened to circulate the refrigerants having a relatively high temperature along the evaporator 68, and defrosting heaters installed at the lower portion of the evaporator 68 are heated to defrost the evaporator 68.

Identically to the first example of the refrigeration cycle, the third example of the refrigeration cycle improves the cooling speed of the refrigerating chamber R more than the general refrigeration cycle by cooling the freezing chamber F and the refrigerating chamber R, respectively, efficiently cools a large capacity of refrigerator, and individually effectively defrosts the freezing chamber F and the refrigerating chamber R.

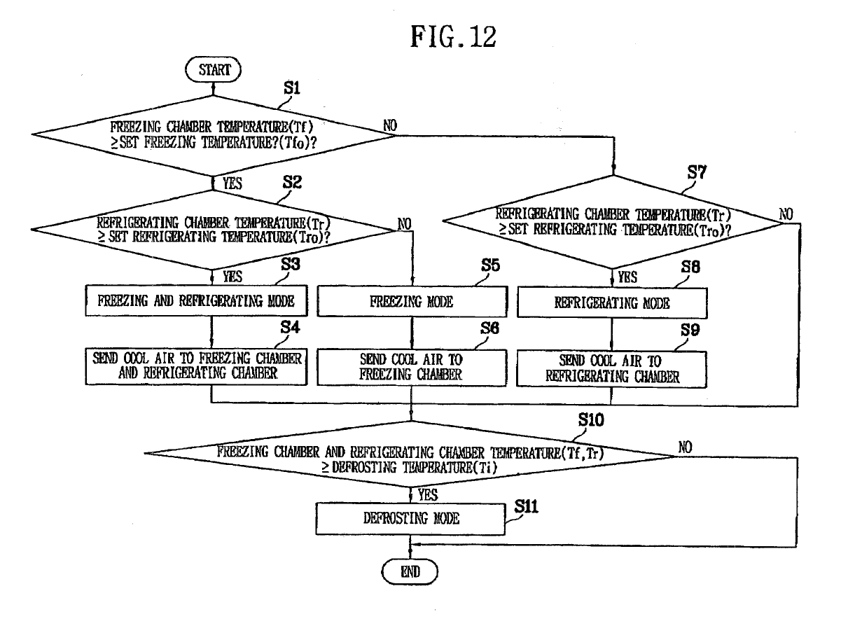

FIG. 12 is a flowchart showing sequential steps of a method for controlling an operation of a refrigerator in accordance with a preferred embodiment of the present invention.

The method for controlling the operation of the refrigerator will now be explained with reference to FIG. 12, and the components of the refrigerator will now be explained with reference to FIGS. 7 to 9.

In the first step, a temperature Tf of a freezing chamber F and a temperature Tr of a refrigerating chamber R are compared with a set freezing temperature Tf₀ and a set refrigerating temperature Tr₀, for sensing a freezing load and a refrigerating load, and an operation mode of the refrigerator is determined (refer to S1, S2, S3, S5, S7 and S8).

In detail, the set freezing temperature Tf₀ and the set refrigerating temperature Tr₀ are set by the user or automatically set, and the temperature Tf of the freezing chamber F and the temperature Tr of the refrigerating chamber R sensed in the freezing chamber F and the refrigerating chamber R are compared with the set freezing temperature Tf₀ and the set refrigerating temperature Tr₀, thereby determining the operation mode of the refrigerator.

Here, when the temperature Tf of the freezing chamber F is higher than the set freezing temperature Tf₀ and the temperature Tr of the refrigerating chamber R is higher than the set refrigerating temperature Tr₀, a freezing and refrigerating mode is selected, when the temperature Tf of the freezing chamber F is higher than the set freezing temperature Tf₀ but the temperature Tr of the refrigerating chamber R is lower than the set refrigerating temperature Tr₀, a freezing mode is selected, when the temperature Tf of the freezing chamber F is lower than the set freezing temperature Tf₀ but the temperature Tr of the refrigerating chamber R is higher than the set refrigerating temperature Tr₀, a refrigerating mode is selected, and when the temperature Tf of the freezing chamber F is lower than the set freezing temperature Tf₀ and the temperature Tr of the refrigerating chamber R is lower than the set refrigerating temperature Tr₀, a cooling mode is not selected.

In the second step, a cooling operation is performed by sending cool air to the freezing chamber F and the refrigerating chamber R, the freezing chamber F or the refrigerating chamber R according to the mode set in the first step (refer to S4, S6 and S9).

Here, when the freezing and refrigerating mode is selected, a compression flow rate and a decompression degree are maximized, and the cool air is sent to the freezing chamber F and the refrigerating chamber R.

Therefore, refrigerants are compressed, condensed, expanded and evaporated sequentially through the compressor 62, the condenser 64, the expansion means 66 and the evaporator 68, for cooling air near the evaporator 68. Here, the ambient air can be rapidly cooled by remarkably controlling the compression flow rate and the decompression degree. When a freezing chamber fan 72 and a refrigerating chamber fan 74 installed at the upper portions of a freezing chamber side region 68a and a refrigerating chamber side region 68b of the evaporator 68 are operated, the cool air passing through the freezing chamber side region 68a of the evaporator 68 is circulated in the freezing chamber F, and the cool air passing through the refrigerating chamber side region 68b of the evaporator 68 is circulated in the refrigerating chamber R.

When the freezing mode is selected, the compression flow rate and the decompression degree are relatively remarkably controlled, and the cool air is sent merely to the freezing chamber F.

Only the freezing chamber fan 72 is operated, and thus the cool air passing through the freezing chamber side region 68a of the evaporator 68 is circulated in the freezing chamber F.

In the freezing mode, if the temperature Tr of the refrigerating chamber R gets higher than the set refrigerating temperature Tr₀, part of the cool air of the freezing chamber F can be supplied to the refrigerating chamber R.

When the refrigerating mode is selected, the compression flow rate and the decompression degree are relatively slightly controlled, and the cool air is sent merely to the refrigerating chamber R.

Only the refrigerating chamber fan 74 is operated, and thus the cool air passing through the refrigerating chamber side region 68b of the evaporator 68 is circulated in the refrigerating chamber R.

Especially, in the refrigerating mode, a temperature of the evaporator 68 is preferably higher than that of the freezing chamber F and lower than that of the refrigerating chamber R.

In the third step, while the cooling operation is performed in each mode in the second step, the temperature Tf of the freezing chamber F and the temperature Tr of the refrigerating chamber R are compared with a previously-inputted defrosting temperature Ti, and a defrosting mode is determined according to the comparison result (refer to S10 and S11).

Here, the surface of the evaporator 68 may be frosted during the cooling operation in each mode. The frosted surface of the evaporator 68 reduces heat exchange efficiency of the evaporator 68. Accordingly, the surface of the evaporator 68 needs to be defrosted.

Because the evaporator 68 does not perform a heat exchange operation with ambient air due to frost, the temperature Tf of the freezing chamber F or the temperature Tr of the refrigerating chamber R relatively increases. If the temperature Tf of the freezing chamber F or the temperature Tr of the refrigerating chamber R gets higher than the defrosting temperature Ti, the defrosting mode is started.

In detail, in the defrosting mode, in a state where the refrigerants are stopped not to flow, the refrigerating chamber fan 74 is operated so that the air of the refrigerating chamber R having a relatively high temperature can be sent and circulated to defrost the refrigerating chamber side region 68b of the evaporator 68. Here, the freezing chamber side region 68a of the evaporator 68 is also defrosted by heat transfer effects.

In addition, in the defrosting mode, the high temperature high pressure liquid refrigerants are supplied to the evaporator 68, and the refrigerating chamber fan 74 is rotatably operated, thereby efficiently performing the defrosting operation.

Furthermore, in the defrosting mode, defrosting heaters installed at the lower portion of the evaporator 68 are heated to rapidly perform the defrosting operation.

As discussed earlier, the side-by-side type refrigerator where the freezing chamber F and the refrigerating chamber R are disposed side by side in accordance with the preferred embodiments of the present invention has been described with reference to the accompanying drawings. However, it is understood that the present invention should not be limited to these preferred embodiments but various changes and modifications can be made by one skilled in the art within the spirit and scope of the present invention as hereinafter claimed.

1-45. (canceled)

46. A refrigerator, comprising:
a compressor configured to compress refrigerants into high temperature high pressure gas refrigerants;
a condenser configured to condense the refrigerants compressed in the compressor into high temperature high pressure liquid refrigerants;
a decompression device configured to expand the refrigerants condensed in the condenser into low temperature low pressure liquid refrigerants;
an evaporator configured to evaporate the refrigerants expanded in the decompression device into low temperature low pressure gas refrigerants, wherein a heat exchange region of the evaporator is divided into a freezing chamber side region and a refrigerating chamber side region by a blocking plate, wherein a plurality of grooves are formed on a surface of the blocking plate such that the plurality of grooves generate turbulent flow in cool air flowing along the surface of the blocking plate and through the evaporator;
a freezing chamber circulation passage formed in the refrigerator and configured to supply cool air from the freezing chamber side region into a freezing chamber;
a refrigerating chamber circulation passage formed in the refrigerator that is separate from the freezing chamber circulation passage, wherein the refrigerating chamber circulation passage is configured to supply cool air from the refrigerating chamber side region into a refrigerating chamber;
a freezing chamber fan installed in the freezing chamber circulation passage and configured to direct cool air to the freezing chamber; and
a refrigerating chamber fan installed in the refrigerating chamber circulation passage and configured to direct cool air to the refrigerating chamber.

47. The refrigerator of claim 46, wherein the evaporator is installed so that the freezing chamber side region and the refrigerating chamber side region of the evaporator are divided by a cross wall that separates the freezing chamber from the refrigerating chamber such that the cross wall functions as the blocking plate.

48. The refrigerator of claim 47, wherein the plurality of grooves are formed on a surface of the cross wall.

49. The refrigerator of claim 46, wherein the evaporator is a straight type thin heat exchanger on which a plurality of cooling fins are installed vertically to a refrigerant tube.

50. A refrigerator, comprising:
a compressor configured to compress refrigerants into high temperature high pressure gas refrigerants;
a condenser configured to condense the refrigerants compressed in the compressor into high temperature high pressure liquid refrigerants;
a decompression device configured to expand the refrigerants condensed in the condenser into low temperature low pressure liquid refrigerants;
an evaporator configured to evaporate the refrigerants expanded in the decompression device into low temperature low pressure gas refrigerants, wherein a heat exchange region of the evaporator is divided into a freezing chamber side region and a refrigerating chamber side region by a blocking plate;
a freezing chamber circulation passage formed in the refrigerator and configured to supply cool air from the freezing chamber side region into a freezing chamber;
a refrigerating chamber circulation passage formed in the refrigerator that is separate from the freezing chamber circulation passage, wherein the refrigerating chamber circulation passage is configured to supply cool air from the refrigerating chamber side region into a refrigerating chamber;
a freezing chamber fan installed in the freezing chamber circulation passage and configured to direct cool air to the freezing chamber; and
a refrigerating chamber fan installed in the refrigerating chamber circulation passage and configured to direct cool air to the refrigerating chamber, wherein the evaporator is a straight type thin heat exchanger on which a plurality of cooling fins are installed vertically to a refrigerant tube, and wherein the evaporator is installed so that an interval between adjacent cooling fins of the plurality of cooling fins in the freezing chamber side region of the evaporator is larger than an interval between adjacent cooling fins of the plurality of cooling fins in the refrigerating chamber side region of the evaporator.

51. The refrigerator of claim 50, wherein the freezing chamber side region of the evaporator has a larger heat exchange area than the refrigerating chamber side region of the evaporator.

52. The refrigerator of claim 50, wherein at least one defrosting heater is installed at a lower portion of the evaporator and is configured to defrost the freezing chamber side region and the refrigerating chamber side region of the evaporator.

53. The refrigerator of claim 52, wherein the at least one defrosting heater comprises radiant heaters.

54. The refrigerator of claim 52, wherein the at least one defrosting heater comprises a defrosting heater for the freezing chamber having a large capacity installed at the lower portion of the freezing chamber side region of the evaporator and a defrosting heater for the refrigerating chamber having a small capacity installed at the lower portion of the refrigerating chamber side region of the evaporator.

55. The refrigerator of claim 54, wherein the at least one defrosting heater comprises radiant heaters.

56. A refrigerator, comprising:
a compressor configured to compress refrigerants into high temperature high pressure gas refrigerants;
a condenser configured to condense the refrigerants compressed in the compressor into high temperature high pressure liquid refrigerants;
a decompression device configured to expand the refrigerants condensed in the condenser into low temperature low pressure liquid refrigerants;
an evaporator configured to evaporate the refrigerants expanded in the decompression device into low temperature low pressure gas refrigerants, wherein a heat exchange region of the evaporator is divided into a freezing chamber side region and a refrigerating chamber side region by a blocking plate;
a freezing chamber circulation passage formed in the refrigerator and configured to supply cool air from the freezing chamber side region into a freezing chamber, wherein a freezing chamber fan is installed in the freezing chamber circulation passage and is configured to direct cool air to the freezing chamber, and wherein in a freezing mode for making a temperature of the freezing chamber reach a set freezing temperature, the cool air is supplied into the freezing chamber by operating the freezing chamber fan;
a refrigerating chamber circulation passage formed in the refrigerator that is separate from the freezing chamber circulation passage, wherein the refrigerating chamber circulation passage is configured to supply cool air from the refrigerating chamber side region into a refrigerating chamber, wherein a refrigerating chamber fan is installed in the refrigerating chamber circulation passage and is configured to direct cool air to the refrigerating chamber, and wherein in a refrigerating mode for making a temperature of the refrigerating chamber reach a set refrigerating temperature, the cool air is supplied into the refrigerating chamber by operating the refrigerating chamber fan; and
a cross wall that separates the freezing chamber from the refrigerating chamber, wherein a connection passage is formed in the cross wall between the freezing chamber and the refrigerating chamber so as to provide for passage of cool air from the freezing chamber directly into the refrigerating chamber therethrough, wherein a damper is installed in the connection passage so as to selectively open and close the connection passage, and wherein the cool air can be selectively supplied from the freezing chamber to the refrigerating chamber by opening the damper when the temperature of the refrigerating chamber is higher than the set refrigerating temperature.

57. The refrigerator of claim 56, wherein the evaporator is a straight type thin heat exchanger on which a plurality of cooling fins are installed vertically to a refrigerant tube.

58. The refrigerator of claim 56, wherein the compressor is a capacity variable compressor which can vary a flow rate of the refrigerants circulated along the evaporator.

59. The refrigerator of claim 56, wherein the freezing chamber fan is installed at an upper portion of the freezing chamber side region of the evaporator, and is configured to send the cool air to the freezing chamber, and the refrigerating chamber fan is installed at an upper portion of the refrigerating chamber side region of the evaporator side by side with the freezing chamber fan, and is configured to send the cool air to the refrigerating chamber.

60. The refrigerator of claim 59, wherein the freezing chamber fan and the refrigerating chamber fan are sirocco fans configured to suck the cool air in an axial direction and discharge the air in a circumferential direction.

61. The refrigerator of claim 59, wherein a first motor configured to drive the freezing chamber fan is installed at an upper portion of the freezing chamber side region of the evaporator, and a second motor configured to drive the refrigerating chamber fan is installed at an upper portion of the refrigerating chamber side region of the evaporator, next to the freezing chamber fan and the first motor.

62. The refrigerator of claim 61, wherein the first and second motors are brushless DC motors.

63. The refrigerator of claim 56, wherein the decompression device comprises a freezing expansion valve and a refrigerating expansion valve installed side by side between the condenser and the evaporator to combine refrigerant tubes formed at the front and rear ends, the freezing expansion valve and the refrigerating expansion valve being different in capacity.

64. The refrigerator of claim 63, wherein the decompression device further comprises an auxiliary expansion valve installed between the evaporator and the compressor, configured to decompress the refrigerants from the evaporator and supply the refrigerants to the compressor.

65. The refrigerator of claim 64, wherein the freezing expansion valve has a relatively larger capacity than the refrigerating expansion valve.

66. The refrigerator of claim 63, wherein the freezing expansion valve and the refrigerating expansion valve are capillary tubes.

67. The refrigerator of claim 63, further comprising a valve device installed between the condenser and the freezing expansion valve and the refrigerating expansion valve, configured to selectively supply the refrigerants from the condenser to the freezing expansion valve or the refrigerating expansion valve.

68. The refrigerator of claim 67, wherein the valve device is a three way valve installed on a refrigerant tube branched from the condenser into the freezing expansion valve and the refrigerating expansion valve, configured to vary a passage of the refrigerants.

69. The refrigerator of claim 67, wherein the valve device comprises first and second solenoid valves installed on refrigerant tubes formed at the front ends of the freezing expansion valve and the refrigerating expansion valve, configured to vary a passage of the refrigerants.

70. The refrigerator of claim 67, wherein, in the freezing mode for making the temperature of the freezing chamber reach a set freezing temperature, the valve device directs the refrigerants to pass through the freezing expansion valve, a freezing chamber fan is operated, and a refrigerating chamber fan is stopped.

71. The refrigerator of claim 67, wherein, in the refrigerating mode for making the temperature of the refrigerating chamber reach a set refrigerating temperature, the valve device directs the refrigerants to pass through the refrigerating expansion valve, a refrigerating chamber fan is operated, and a freezing chamber fan is stopped.

72. The refrigerator of claim 56, wherein, in the freezing mode for making the temperature of the freezing chamber reach the set freezing temperature, when the temperature of the refrigerating chamber gets higher than the set refrigerating temperature, the damper is opened to supply the cool air of the freezing chamber to the refrigerating chamber.

73. A method for controlling an operation of a refrigerator, comprising:
compressing refrigerants into high temperature high pressure gas refrigerants according to a freezing load or a refrigerating load applied to a freezing chamber or a refrigerating chamber;
condensing the condensed refrigerants into high temperature high pressure liquid refrigerants by performing a heat exchange operation with air;
decompressing the compressed refrigerants into low temperature low pressure liquid refrigerants by controlling a decompression degree according to the load;
generating cool air by evaporating the decompressed refrigerants into low temperature low pressure gas refrigerants by performing a heat exchange operation in an evaporator; and
sending the cool air from the evaporator to the freezing chamber, to the refrigerating chamber, or to both the freezing chamber and the refrigerating chamber simultaneously, wherein the cool air is selectively sent to the freezing chamber, the refrigerating chamber or both the freezing chamber and the refrigerating chamber based on an applied load,
wherein in a freezing mode for making a temperature of the freezing chamber reach a set freezing temperature, the cool air is sent to the freezing chamber by operating a freezing chamber fan configured to send the cool air generated in a freezing chamber side region of the evaporator, wherein in a refrigerating mode for making a temperature of the refrigerating chamber reach a set refrigerating temperature, the cool air is sent to the refrigerating chamber by operating a refrigerating chamber fan configured to send the cool air generated in a refrigerating chamber side region of the evaporator, and wherein the cool air can be selectively supplied from the freezing chamber into the refrigerating chamber through a connection passage formed in a cross wall that separates the freezing chamber and the refrigerating chamber when the temperature of the refrigerating chamber is higher than the set refrigerating temperature.

74. The method of claim 73, further comprising setting a freezing load so that a temperature of the freezing chamber can reach a set freezing temperature, or setting a refrigerating load so that a temperature of the refrigerating chamber can reach a set refrigerating temperature in the compressing.

75. The method of claim 74, wherein, when the load increases, a compression flow rate of the refrigerants also increases in the compressing.

76. The method of claim 74, wherein, in the compressing, the compression flow rate of the refrigerants is higher in application of the freezing load than in application of the refrigerating load.

77. The method of claim 75, wherein, in the compressing, the compression flow rate of the refrigerants is higher in application of the freezing load than in application of the refrigerating load.

78. The method of claim 73, wherein, in the decompressing, a decompression degree of the refrigerants is higher in application of the freezing load than in application of the refrigerating load.

79. The method of claim 73, wherein, in the evaporating, when the freezing load and the refrigerating load are applied at the same time, the cool air generated in the freezing chamber side region of the evaporator is sent to the freezing chamber by a freezing chamber fan, and the cool air generated in the refrigerating chamber side region of the evaporator is sent to the refrigerating chamber by a refrigerating chamber fan.

80. The method of claim 73, wherein, in the evaporating, when only the freezing load is applied, the cool air generated in the freezing chamber side region of the evaporator is sent only to the freezing chamber by the freezing chamber fan, and when only the refrigerating load is applied, the cool air generated in the refrigerating chamber side region of the evaporator is sent only to the refrigerating chamber by the refrigerating chamber fan.

81. The method of claim 80, wherein, in the evaporating, while only the freezing load is applied to send the cool air only to the freezing chamber, when the refrigerating load is additionally applied, the connection passage linked between the freezing chamber and the refrigerating chamber is opened to supply the cool air of the freezing chamber to the refrigerating chamber.

82. The method of claim 80, wherein, in the evaporating, while only the refrigerating load is applied to send the cool air to the refrigerating chamber, a temperature of the evaporator is set higher than the temperature of the freezing chamber and lower than the temperature of the refrigerating chamber.

83. The method of claim 80, further comprising, in the evaporating, performing a defrosting operation when the temperature of the freezing chamber or the temperature of the refrigerating chamber gets higher than a defrosting temperature, although the freezing load or the refrigerating load is applied to send the cool air to the freezing chamber or the refrigerating chamber.

84. The method of claim 83, wherein the defrosting operation operates only the refrigerating chamber fan in a state where the refrigerants are stopped not to flow.

85. The method of claim 83, wherein the defrosting operation does not decompress but directly supplies the high temperature high pressure condensed refrigerants to the evaporator, and rotatably operates the refrigerating chamber fan.

86. The method of claim 85, wherein the defrosting operation further operates defrosting heaters installed at a lower portion of the evaporator to heat the evaporator.

87. The method of claim 73, wherein a blocking plate divides a heat exchange region of the evaporator into the freezing chamber side region and the refrigerating chamber side region.

88. A refrigerator, comprising:
a compressor configured to compress refrigerants into high temperature high pressure gas refrigerants;
a condenser configured to condense the refrigerants compressed in the compressor into high temperature high pressure liquid refrigerants;
a decompression device configured to expand the refrigerants condensed in the condenser into low temperature low pressure liquid refrigerants;
an evaporator configured to evaporate the refrigerants expanded in the decompression device into low temperature low pressure gas refrigerants, wherein a heat exchange region of the evaporator is divided into a freezing chamber side region and a refrigerating chamber side region; and
an air blast device linked, respectively, to the freezing chamber side region and the refrigerating chamber side region of the evaporator, configured to send cool air from each region to a freezing chamber and a refrigerating chamber, wherein the evaporator is installed so that the freezing chamber side region and the refrigerating chamber side region of the evaporator are divided by a cross wall that separates the freezing chamber from the refrigerating chamber, wherein in a freezing mode for making a temperature of the freezing chamber reach a set freezing temperature, the cool air is sent to the freezing chamber by operating the air blast device on the freezing chamber side region of the evaporator, and wherein in a refrigerating mode for making a temperature of the refrigerating chamber reach a set refrigerating temperature, the cool air is sent to the refrigerating chamber by operating the air blast device on the refrigerating chamber side region of the evaporator, and wherein a connection passage is formed on the cross wall between the freezing chamber and the refrigerating chamber, so that the cool air of the freezing chamber can be supplied to the refrigerating chamber, and a damper is installed on the connection passage to open/close the connection passage and wherein the cool air can be selectively supplied from the freezing chamber to the refrigerating chamber by opening the damper when the temperature of the refrigerating chamber is higher than the set refrigerating temperature.
